(19) United States
(12) Patent Application Publication
(10) Pub. No.: US 2026/0147539 A1
(43) Pub. Date: May 28, 2026

(54) SYSTEMS AND METHODS FOR MODEL PARAMETER COMPRESSION

(71) Applicant: Agora Lab, Inc., Santa Clara, CA (US)

(72) Inventor: Wei Dai, Shanghai (CN)

(21) Appl. No.: 18/961,083

(22) Filed: Nov. 26, 2024

(51) Int. Cl. G06F 7/544; G06F 7/76

(52) U.S. Cl. CPC G06F 7/544; G06F 7/76

(57) ABSTRACT

The methods and systems for model parameter compression includes selecting a total number of bits in which to store a plurality of parameters wherein the number of bits is divided into a signal bit, an exponent set of bits and a fractional set of bits. Additionally, a maximum parameter and a minimum parameter of the plurality of parameters is received. The method maximizes the number of bits in the fractional set of bits subject to two constraints: 1) the fractional set of bits and the exponent set of bits is less than or equal to one less than the total number of bits, and 2) a relational model of the number bits in the exponent set of bits to a range of parameters. Once the fractional set of bits and the exponent set of bits are thus determined, the system may convert the plurality of parameters into a plurality of converted values utilizing a mapping function.

### BACKGROUND

The present invention relates in general to the field of compression, and more specifically to methods, computer programs and systems for model parameter compression. Machine learning and deep learning models are being deployed at an accelerated pace across all industry segments and within our personal lives. These models rely upon parameters to be trained and operated. With the increasing number of parameters associated with these complex models the overall size of each model is increasing dramatically. This leads to extremely large and cumbersome models, that require significant data storage and bandwidth to transmit.

Currently, there are several standards for computer number formats. For example, there are several computer number formats defined to store parameters put forth by the Institute of Electrical and Electronics Engineers (IEEE). These include int8, float 16, float 32, double, etc. Each of these number formats attempts to achieve a balance between precision and range.

Float 32 for example, also known as single-precision floating-point format occupying 32 bits in computer memory. It has a floating point radix point and a wide dynamic range around it. A signed 32-bit integer variable has a maximum value of 2³¹−1=2,147,483,647. In contrast, a 32-bit base-2 floating-point variable has a maximum value of (2−2⁻²³)×2¹²⁷≈3.4028235×10³⁸. All integers with fewer than seven decimals can be converted exactly into a float 32 value.

Float 32 specifies a sign bit, 8 bits for the exponent width and 23 bits for significand precision. This provides between 6 to 9 significant decimal digits precision. The sign bit determines the sign of the number. The exponent field is an 8-bit unsigned integer between 0 to 255. Biased exponent values of 0 and 255 are reserved for special numbers. The true significand of normal numbers includes 23 fraction bits to the right of the binary point and an implicit leading bit with value of 1.

Contrast this with float 16, or half precision, which is a number format that occupies 16-bits in computer memory. Float 16 includes 1 sign bit, 5 bits for the exponent and 10 bits for the significand precision. This results in a maximum value of 6.55×10⁴. Clearly, the precision afforded float 16 is less than that of float 32, but at the advantage of requiring half as much computer storage.

Currently, there is a recognition for the need to compress model parameters, and typically this is achieved by merely converting the float 32 precision to a float 16 precision format. This results in a few problems however: 1) the range of float 16 is from 2¹⁶ to 2⁻²⁴, and the original range of the model parameter may not fit this range resulting in clipping to avoid the overflow; 2) the original range of the model parameter may only be variations in (0,1), which is a significant waste if float 16 is used to represent the parameter; and 3) some model parameters which do not require high levels of precision does not require the 10 fraction bits in float 16.

Given that there is great value in compressing model parameters in a manner that avoids clipping or wasted storage, enhanced model parameter compression is provided.

### SUMMARY

The present systems and methods relate to machine learning model parameter handling, and particularly to improved compression of model parameters. Such systems and methods enable reduced storage and bandwidth requirements for the storage and transfer of model parameters while maintaining parameter precision.

In some embodiments, the methods and systems for model parameter compression includes selecting a total number of bits in which to store a plurality of parameters wherein the number of bits is divided into a signal bit, an exponent set of bits and a fractional set of bits. Additionally, a maximum parameter and a minimum parameter of the plurality of parameters is received. The systems and methods may maximize the number of bits in the fractional set of bits subject to two constraints: 1) the number of bits in the fractional set of bits and a number of bits in the exponent set of bits is less than or equal to one less than the total number of bits, and 2) a relational model of the number bits in the exponent set of bits to a range of the parameters, wherein the range of the parameters is dependent upon the maximum parameter and the minimum parameter of the plurality of parameters. Once the number of bits in the fractional set of bits and the number of bits in the exponent set of bits are thus determined, the system may convert the plurality of parameters into a plurality of converted values utilizing a mapping function.

In some cases the system may determine the minimum parameter of the plurality of parameters is below a threshold. In such cases the relational model is two to an exponent of the number of bits in the exponent set of bits minus one is greater than or equal to a base two log of the maximum parameter, and the mapping function is given as:

$$f ( p ) = \frac{p}{a} m ( x , y )$$

where, p is the parameter value, a is the maximum parameter, x is the number of bits in the exponent set of bits, y is the number of bits in the fractional set of bits and:

$$m ( x , y ) = {2}^{( {2}^{x} - 1 ) - {2}^{x - 1}} ( 1 + \frac{{2}^{y} - 1}{{2}^{y}} ) .$$

Additionally, when the minimum parameter is a negative number, the system may shift the range of the parameters to center around zero. In which case the relational model becomes:

$${2}^{x - 1} \geq {log}_{2} \frac{( {a}_{p} - {a}_{n} )}{2} ,$$

where aₚ is the maximum parameter, and aₙ is the minimum parameter. Further, the mapping function is given as:

$$f ( p ) = \frac{( p - \frac{( {a}_{p} - {a}_{n} )}{2} )}{\frac{( {a}_{p} - {a}_{n} )}{2}} m ( x , y ) .$$

Otherwise, if the minimum parameter of the plurality of parameters is at or above a threshold, then the relational model becomes:

$${2}^{x} + y - 1 \geq {log}_{2} \frac{a}{b} ,$$

where a is the maximum parameter, and b is the minimum parameter. Likewise, the mapping function is given as:

$$f ( p ) = \frac{( p - b )}{( a - b )} ( m ( x , y ) - n ( x , y ) ) + n ( x , y ) , where n ( x , y ) = {2}^{- ( {2}^{x - 1} - 1 )} ( 0 + \frac{1}{2 y} ) .$$

Additionally, in cases where the conversion error is above a threshold the total number of bits may be increased. Further, the system may receive the number of the plurality of parameters, receive the total number of bits, and group binary coding of each parameter together with other parameters to constitute a set number of 8 bits coding units and pad any unused bits as zeros.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example block diagrams of a system for compressing model parameters, in accordance with some embodiment;

FIG. 2 is a flow diagram for an example process of model parameter handling, in accordance with some embodiments;

FIG. 3 is a flow diagram for an example process of model parameter compression, in accordance with some embodiments;

FIG. 4 is a flow diagram for an example sub-process of an expanded compression method, in accordance with some embodiments;

FIG. 5 is a flow diagram for an example sub-process of a simplified compression method, in accordance with some embodiments;

FIG. 6 is a flow diagram for an example process of compacted compressed parameter storage, in accordance with some embodiments; and

FIGS. 7A and 7B are illustrations of computer systems capable of implementing the model parameter compression, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

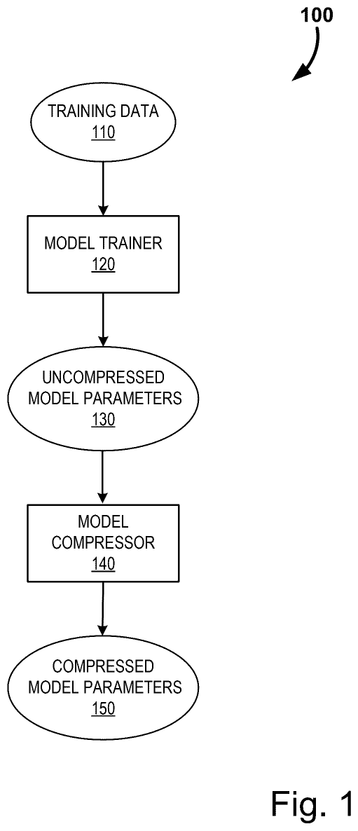

The present invention relates to systems and methods for model parameter compression. To facilitate discussions, FIG. 1 is an example of a system for model parameter handling, shown generally at 100. Initially training data 110 is consumed by the model trainer 120. Often these model trainer systems are large scale GPU farms or other super-computing clusters. Model training can often be a major undertaking, consuming significant computational power as well as electricity. The output of the mode trainer is a trained model comprised of model parameters. Often these model parameters are stored in a high precision format such as float 32, which can be considered an uncompressed format model parameters 130. These uncompressed model parameters 130 may consume significant storage requirements. Likewise, transfer of the model parameters over a network, such as the internet, may require significant bandwidth and time. As such, there is a strong need for model parameter compression.

The model compressor 140 employes one or more compression techniques which maintain the needed precision of the model parameter, while minimizing the storage requirements. Additionally, the model compressor 140 may also take the compressed model parameters and perform compacted storage of the resulting values. This results in a set of compressed model parameters 150.

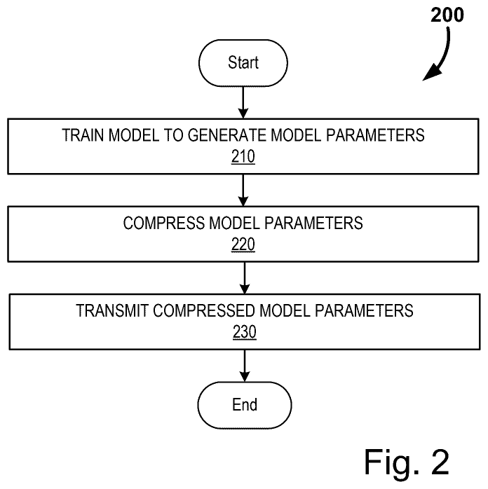

FIG. 2 provides a high-level process diagram for the example method of model parameter handling, shown generally at 200. Initially, the process starts by training a machine learning model to generate model parameters, at 210. Subsequently, the model parameters are compressed, at 220. And lastly, the compressed parameters are transmitted or otherwise stored for later retrieval for model operation, at 230.

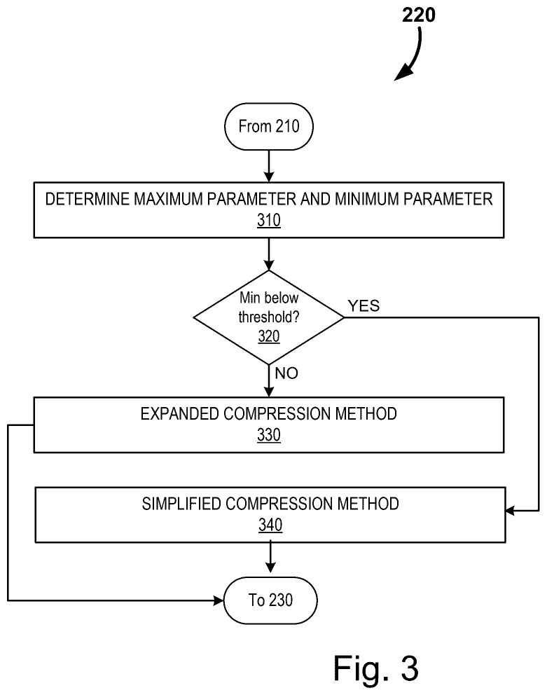

FIG. 3 provides a greater detailed view of the process of model compression. For a fixed model, the range of all the parameters is known. As the model parameters are fixed, the expected precision of the input feature is known. Furthermore, model parameters should not include a Not a Number (NaN) or an infinite (inf) value.

Initially, the process determines a maximum and a minimum for the parameter, at 310. Maximum values and minimum values may be calculated using the following equations which allows for the calculation of the range:

$$float range value calculation \text{:} p ( x , y ) = {2}^{exponent - {2}^{x - 1}} ( 1 + \frac{fraction}{{2}^{y}} ) , if exponent \neq 0 \qquad Equation 1$$

$$float range value calculation \text{:} p ( x , y ) = {2}^{- {2}^{x - 1}} ( 0 + \frac{fraction}{{2}^{y}} ) , if exponent = 0 \qquad Equation 2$$

Where x is the exponent bits for the float and y is the fraction bits for the float value. Thus the maximum value m for a given parameter can be calculated as the following:

$$Max value calculation : m ( x , y ) = {2}^{( {2}^{x} - 1 ) - {2}^{x - 1}} ( 1 + \frac{{2}^{y} - 1}{{2}^{y}} ) \qquad Equation 3$$

$$Min value calculation : n ( x , y ) = {2}^{- ( {2}^{x - 1} - 1 )} ( 0 + \frac{1}{{2}^{y}} ) \qquad Equation 4$$

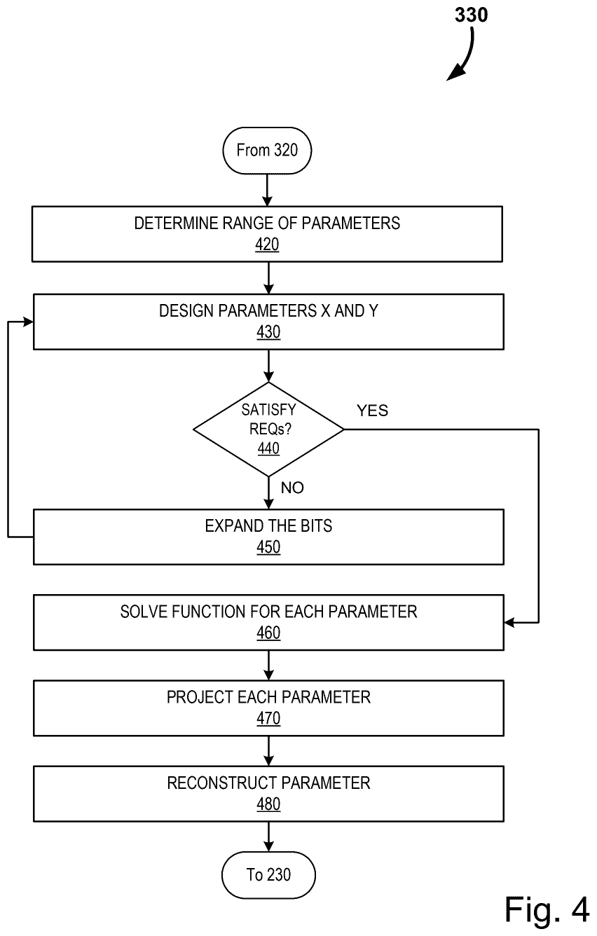

Parameters with minimum value below a given threshold may be identified by the process at 320. These cases allow for a simplified compression method to be employed, at 340. If the minimum value is larger than the threshold, however, an expanded compression methodology may be applied, at 330. FIG. 4 provides greater detail into the expanded compression method. The expanded compression method involves determining the range of the parameters, at 420. The range of the float is provided by the following equation:

$$float range \text{:} {log}_{2} \frac{m ( x , y )}{n ( x , y )} \approx {log}_{2} {2}^{{2}^{x} - 1 + y} = {2}^{x} + y - 1 \qquad Equation 5$$

As the model parameters should never be NaN or inf, the exponent value should never be 1, and therefore this special case does not need to be solved for.

Suppose for example, the maximum parameter is a, and the minimum parameter is b. Also assume for this example, that all parameters are positive. The range r for these parameters would be given by:

$$Example parameter range \text{:} r = {log}_{2} \frac{a}{b} \qquad Equation 6$$

After the range is thus determined, the parameters x and y may be designed according to certain requirements, at 430. Using equations 1 and 2 above, the parameters for x and y can be designed which satisfies the following:

$$Length definition \text{:} x + y \leq bits - 1 \qquad Equation 7$$

Where bits are the total number/length of bits used to store the model parameters. And wherein the following is also satisfied:

$$range definition \text{:} {2}^{x} + y - 1 \geq r \qquad Equation 8$$

Given these definitions, an appropriate x and y may be solved for given a set number of bits. Initially, a lower number of bits may be utilized, such as 6 bits. The system may decide if a suitable x and y may be formulated given the requirements, at 440. If no x and y can be found that satisfies the restraints, a larger bit number may be employed. The process may iteratively check at an expanded number of bits until a suitable x and y value may be found, at 450.

Once a suitable bit size is determined, and a suitable x and y have been solved for, at 460, for each model parameter p the following function may be solved:

$$Equation 9$$

$$Mapping Function \text{:} f ( p ) = \frac{( p - b )}{( a - b )} ( m ( x , y ) - n ( x , y ) ) + n ( x , y )$$

The maximum parameter a may be projected to m (x,y) and the minimum parameter b may be projected to n (x,y). All other parameters between a and b will be projected to a number between m (x,y) and n (x,y), at 470. This results in all parameters being scaled and fully represents the bits floating number. As a, b, x, y and f (p) are all known, it is simple to reconstruct p using Equation 9, at 480. This concludes the expanded compression methodology. An example of the above described expanded compression methodology will be provided to help in clarification. Assume for example, the following parameter values are provided by the model training: 392.13, 113.22, 3.21, 82.3 and 1.2. Also assume that the system wishes to utilize 8 bits to store these parameters. Using Equations 7 and 8 we find the following:

$$Example 1.1 \text{:} x + y \leq 7 \qquad Equation 10$$

$$Example 1.2 \text{:} {2}^{x} + y - 1 \geq {log}_{2} \frac{392.13}{1.2} \approx 8.35 \qquad Equation 11$$

There are a number of choices that may be employed for x and y that meet these requirements. For example (x,y) may equal any of (3,4), (4,3), (5,2), (6,1), or (7,0). Using (3,4) as an example, in combination with Equation 9, 3 and 4, the following is calculated:

$$Example 1.3 \text{:} f ( p ) = \frac{( p - 1.2 )}{( 392.13 - 1.2 )} ( {2}^{3} ( 1 + \frac{15}{16} ) - {2}^{- 7} ) + {2}^{- 7} \qquad Equation 12$$

This allows all parameters to be converted using this linear relationship as the following:

TABLE 1

| Original | Converted | Bit code | Projected | Error |
|---|---|---|---|---|
| 392.13 | 15.5 | 01111111 | 15.5 | 0.0% |
| 113.22 | 4.4470595 | 01100010 | 4.5 | 1.2% |
| 3.21 | 0.0874669 | 00001100 | 0.09375 | 7.2% |
| 82.3 | 3.2217291 | 01011001 | 3.125 | 3.0% |
| 1.2 | 0.0078125 | 00000001 | 0.0078125 | 0.0% |

A similar analysis could be performed when (x,y)=(4,3), (5,2), (6,1) or (7,0) for example. In the following table, (5,2) may be leveraged instead, resulting in the following parameter conversions:

TABLE 2

| Original | Converted | Bit code | Projected | Error |
|---|---|---|---|---|
| 392.13 | 57344 | 01111111 | 57344 | 0.0% |
| 113.22 | 16431.778 | 01111000 | 16384 | −0.3% |
| 3.21 | 294.83909 | 01100001 | 320 | 8.5% |
| 82.3 | 11896.243 | 01110110 | 12288 | 3.3% |
| 1.2 | 0.0000076 | 00000001 | 0.0000076 | 0.0% |

The last step is to analyze the choice of the selected x and y. Comparing the results of Table 1 and Table 2, the maximum compression error of (5,2) is larger than that of (3,4). Generally, the larger y results in a more accurate compression. Therefore to get the best choice of (x,y) the maximum y value that satisfies Equations 7 and 8 should be used.

This methodology enables the storage of the four extra parameters a, b, x and y. Then the system may convert the compressed parameters back to the original values with little rounding error. For negative parameters, the system can also find another four ‘extra’ parameters and can jointly optimize both the negative and positive values by taking the absolute value of negative parameters, or jointly find the a, b, x and y.

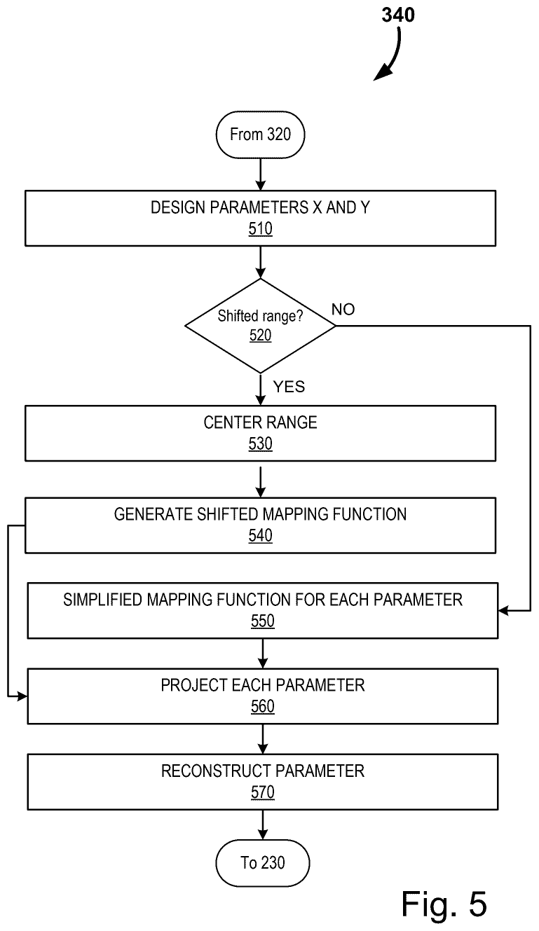

The above described method is especially helpful when the b is large and the overall range of bits are not fully utilized. If the minimum value b was found to be below the threshold earlier, a simplified compression methodology may be alternatively employed. FIG. 5 provides greater detail of this simplified compression methodology. When b is small enough the overall range is almost entirely utilized. If the maximum value of the parameters is a, then (x,y) should satisfy the following while maximizing y:

$$Length definition \text{:} x + y \leq bits - 1 \qquad Equation 13$$

$${2}^{x - 1} \geq {log}_{2} a \qquad Equation 14$$

After the values for x and y have been thereby determined, at 510, a determination is made whether to shift the centroid of the function to be around zero, at 520. This may be desired when the lowest parameter value is negative. In such a situation the maximum value is given as aₚ, and the minimum negative value is given as an. In these situations, the maximum positive value is reset as:

$$Maximum shifted value \text{:} \frac{{a}_{p} - {a}_{n}}{2} \qquad Equation 15$$

The range is thus centered, at 530, and the x and y values may be re-calculated (not illustrated) by maximizing y subject to the following conditions:

$$Length definition \text{:} x + y \leq bits - 1 \qquad Equation 16$$

$${2}^{x - 1} \geq {log}_{2} \frac{( {a}_{p} - {a}_{n} )}{2} \qquad Equation 17$$

Subsequently a shifted mapping function may be generated, at 540, as follows:

$$\begin{matrix}Shifted mapping function & \\ f ( p ) = \frac{( p - \frac{( {a}_{p} - {a}_{n} )}{2} )}{\frac{( {a}_{p} - {a}_{n} )}{2}} m ( x , y ) & Equation 18\end{matrix}$$

Conversely, if the minimum value is not a negative, there is no need to shift the range to center around zero. In which case a simplified mapping function may be generated, at 550. This simplified mapping function may be as follows:

$$\begin{matrix}Simplified mapping function & \\ f ( p ) = \frac{p}{a} m ( x , y ) & Equation 19\end{matrix}$$

Regardless of whether the simplified mapping function or the shifted mapping function is being utilized, the system may next project each parameter in a binary format, at 560, as previously discussed. Parameters may then be reconstructed, at 570.

Regardless if the simplified compression methodology or the enhanced compression methodology is utilized, a check may be made on the reconstituted values to determine the compression error (not illustrated). This check may analyze for a compression error of one or a set number of parameters above a maximum threshold, and/or an average error value above an acceptable threshold. If one or more of these limits are exceeded, then the system can determine that the bit number being utilized is too low (despite meeting the required conditions), and a larger bit may be employed.

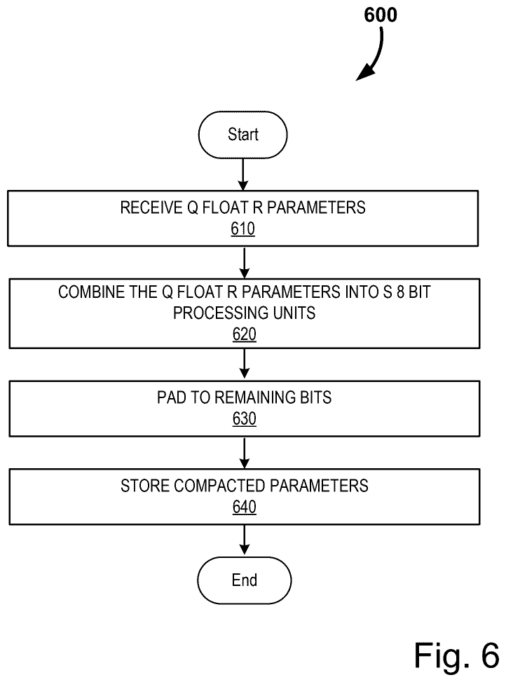

In addition to performing this enhanced compression, the system may further realize storage efficiencies by performing compacted parameter storage, as seen in relation to FIG. 6 at 600. In this example process, the system may receive information regarding the float size Q and the total number R of parameters, at 610. Computer storage generally operates in 8 bit processing units, as such, the system may combine the Q float R parameters into a set number S of these 8 bit processing units, at 620. For example, imagine there are seven parameters (R=7) and the compression is 6 float (Q=6). In this example, we could use 3 bytes, which is 24 bits to store 4 of the 6 float parameters. In a second 3 bytes, the remaining 3 of the 6 float parameters may be stored, and the system may pad the remaining bits as zero, at 630. The compacted parameters may then be stored, at 640, in a manner that allows for retrieval and segregating out the parameters individually.

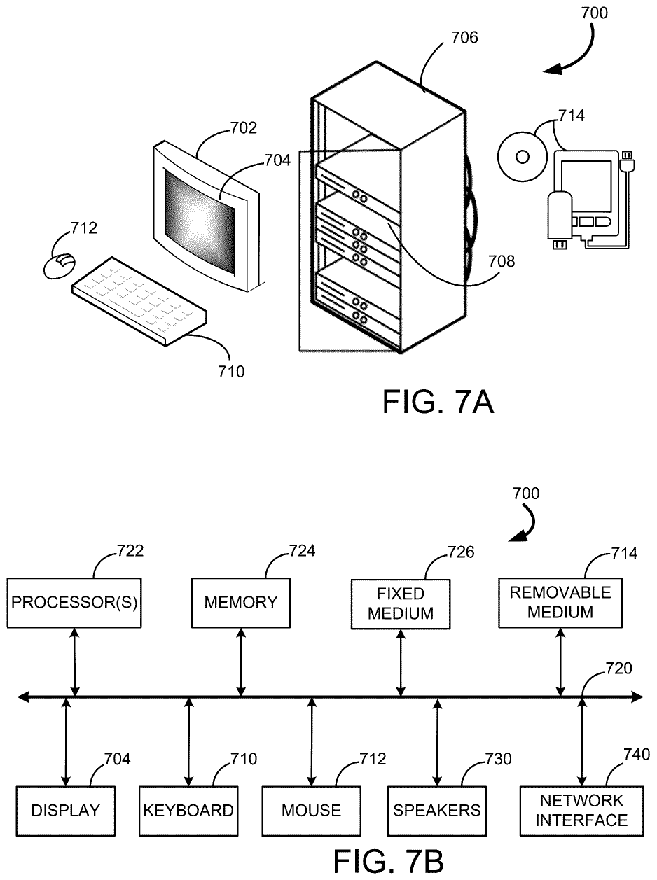

Now that the systems and methods for improved treatment of model parameters have been provided, attention shall now be focused upon apparatuses capable of executing the above functions in real-time. To facilitate this discussion, FIGS. 7A and 7B illustrate a Computer System 700, which is suitable for implementing embodiments of the present invention. FIG. 7A shows one possible physical form of the Computer System 700. Of course, the Computer System 700 may have many physical forms ranging from a printed circuit board, an integrated circuit, and a small handheld device up to a huge supercomputer. Computer system 700 may include a Monitor 702, a Display 704, a Housing 706, server blades including one or more storage Drives 708, a Keyboard 710, and a Mouse 712. Medium 714 is a computer-readable medium used to transfer data to and from Computer System 700. FIG. 7B is an example of a block diagram for Computer System 700. Attached to System Bus 720 are a wide variety of subsystems. Processor(s) 722 (also referred to as central processing units, or CPUs) are coupled to storage devices, including Memory 724. Memory 724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 726 may also be coupled bi-directionally to the Processor 722; it provides additional data storage capacity and may also include any of the computer-readable media described below. Fixed Medium 726 may be used to store programs, data, and the like and is typically a secondary storage medium (such as a hard disk) that is slower than primary storage. It will be appreciated that the information retained within Fixed Medium 726 may, in appropriate cases, be incorporated in standard fashion as virtual memory in Memory 724. Removable Medium 714 may take the form of any of the computer-readable media described below.

Processor 722 is also coupled to a variety of input/output devices, such as Display 704, Keyboard 710, Mouse 712 and Speakers 730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 722 optionally may be coupled to another computer or telecommunications network using Network Interface 740. With such a Network Interface 740, it is contemplated that the Processor 722 might receive information from the network, or might output information to the network in the course of performing the above-described model parameter compression methods. Furthermore, method embodiments of the present invention may execute solely upon Processor 722 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 700 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for compressing model parameters comprising:
selecting a total number of bits in which to store a plurality of parameters wherein the number of bits is divided into a signal bit, an exponent set of bits and a fractional set of bits;
receiving a maximum parameter and a minimum parameter of the plurality of parameters;
maximizing a number of bits in the fractional set of bits subject to two constraints, wherein the two constraints include that the number of bits in the fractional set of bits and a number of bits in the exponent set of bits is less than or equal to the total number of bits minus one, and a relational model of the number bits in the exponent set of bits to a range of the parameters, wherein the range of the parameters is dependent upon the maximum parameter and the minimum parameter of the plurality of parameters; and
converting the plurality of parameters into a plurality of converted values utilizing a mapping function.

2. The method of claim 1, further comprising determining the minimum parameter of the plurality of parameters is below a threshold.

3. The method of claim 2, wherein the relational model is two to an exponent of the number of bits in the exponent set of bits minus one is greater than or equal to a base two log of the maximum parameter.

4. The method of claim 3, wherein the mapping function is given as:
$$f ( p ) = \frac{p}{a} m ( x , y )$$
where, p is the parameter value, a is the maximum parameter, x is the number of bits in the exponent set of bits, y is the number of bits in the fractional set of bits and:
$$m ( x , y ) = {2}^{( {2}^{x} - 1 ) - {2}^{x - 1}} ( 1 + \frac{{2}^{y} - 1}{{2}^{y}} ) .$$

5. The method of claim 2, further comprising when the minimum parameter is a negative number, shifting the range of the parameters to center around zero.

6. The method of claim 5, wherein the relational model becomes:
$${2}^{x - 1} \geq {log}_{2} \frac{( {a}_{p} - {a}_{n} )}{2}$$
where aₚ is the maximum parameter, aₙ is the minimum parameter and x is the number of bits in the exponent set of bits.

7. The method of claim 6, wherein the mapping function is given as:
$$f ( p ) = \frac{( p - \frac{( {a}_{p} - {a}_{n} )}{2} )}{\frac{( {a}_{p} - {a}_{n} )}{2}} m ( x , y )$$
where, p is the parameter value, x is the number of bits in the exponent set of bits, y is the number of bits in the fractional set of bits and:
$$m ( x , y ) = {2}^{( {2}^{x} - 1 ) - {2}^{x - 1}} ( 1 + \frac{{2}^{y} - 1}{{2}^{y}} ) .$$

8. The method of claim 1, further comprising determining the minimum parameter of the plurality of parameters is at or above a threshold.

9. The method of claim 8, wherein the relational model becomes:
$${2}^{x} + y - 1 \geq {log}_{2} \frac{a}{b}$$
where a is the maximum parameter, b is the minimum parameter, x is the number of bits in the exponent set of bits and y is the number of bits in the fractional set of bits.

10. The method of claim 9, wherein the mapping function is given as:
$$f ( p ) = \frac{( p - b )}{( a - b )} ( m ( x , y ) - n ( x , y ) ) + n ( x , y )$$
where, p is the parameter value, and:
$$m ( x , y ) = {2}^{( {2}^{x} - 1 ) - {2}^{x - 1}} ( 1 + \frac{{2}^{y} - 1}{{2}^{y}} ) ; and$$
$$n ( x , y ) = {2}^{- ( {2}^{x - 1} - 1 )} ( 0 + \frac{1}{{2}^{y}} ) .$$

11. The method of claim 1, further comprising increasing the total number of bits when a conversion error is above a threshold.

12. The method of claim 1, further comprising receiving a number of the plurality of parameters, receiving the total number of bits and grouping binary coding of each parameter together with other parameters to constitute a set number of 8 bit coding units and padding any unused bits as zeros.

13. A computerized system for compressing model parameters comprising:
an interface for receiving a total number of bits in which to store a plurality of parameters wherein the number of bits is divided into a signal bit, an exponent set of bits and a fractional set of bits, and receiving a maximum parameter and a minimum parameter of the plurality of parameters;
a processing unit for maximizing a number of bits in the fractional set of bits subject to two constraints, wherein the two constraints include that the number of bits in the fractional set of bits and a number of bits in the exponent set of bits is less than or equal to the total number of bits, and a relational model of the number bits in the exponent set of bits to a range of the parameters, wherein the range of the parameters is dependent upon the maximum parameter and the minimum parameter of the plurality of parameters, and converting the plurality of parameters into a plurality of converted values utilizing a mapping function; and
a database for storing the plurality of converted values.

14. The system of claim 13, wherein the processing unit further determines the minimum parameter of the plurality of parameters is below a threshold.

15. The system of claim 14, wherein the relational model is two to an exponent of the number of bits in the exponent set of bits minus one is greater than or equal to a base two log of the maximum parameter.

16. The system of claim 15, wherein the mapping function is given as:
$$f ( p ) = \frac{p}{a} m ( x , y )$$
where, p is the parameter value, a is the maximum parameter, x is the number of bits in the exponent set of bits, y is the number of bits in the fractional set of bits and:
$$m ( x , y ) = {2}^{( {2}^{x} - 1 ) - {2}^{x - 1}} ( 1 + \frac{{2}^{y} - 1}{{2}^{y}} ) .$$

17. The system of claim 13, wherein the processing unit further determines the minimum parameter of the plurality of parameters is at or above a threshold.

18. The system of claim 17, wherein the relational model becomes:
$${2}^{x} + y - 1 \geq {log}_{2} \frac{a}{b}$$
where a is the maximum parameter, b is the minimum parameter, x is the number of bits in the exponent set of bits and y is the number of bits in the fractional set of bits.

19. The system of claim 18, wherein the mapping function is given as:
$$f ( p ) = \frac{( p - b )}{( a - b )} ( m ( x , y ) - n ( x , y ) ) + n ( x , y )$$
where, p is the parameter value, and:
$$m ( x , y ) = {2}^{( {2}^{x} - 1 ) - {2}^{x - 1}} ( 1 + \frac{{2}^{y} - 1}{{2}^{y}} ) ; and$$
$$n ( x , y ) = {2}^{- ( {2}^{x - 1} - 1 )} ( 0 + \frac{1}{{2}^{y}} ) .$$

20. The system of claim 13, wherein the total number of bits is increased when a conversion error is above a threshold.

21. The system of claim 13, wherein the database further receives a number of the plurality of parameters, receiving the total number of bits and grouping binary coding of each parameter together with other parameters to constitute a set number of 8 bit coding units and padding any unused bits as zeros.
